(19) United States
(12) Patent Application Publication
(10) Pub. No.: US 2012/0090264 A1
(43) Pub. Date: Apr. 19, 2012

(54) Portable Rebate Cutting Machine

(76) Inventor: William John Goss, Mulwala, NSW (AU)

(21) Appl. No.: 13/378,356

(22) PCT Filed: Jun. 9, 2010
(86) PCT No.: PCT/AU10/00724

§ 371 Date: Dec. 14, 2011

(51) Int. Cl. E04B 1/68; B26D 3/00; E04B 2/00

(52) U.S. Cl. 52/741.4; 52/745.09; 83/869

(57) ABSTRACT

A machine (10) for cutting a rebate edge (30) in a building panel (24) has a cutting wheel (12) which can be connected to a source of power for rotating the cutting wheel. There is a planar plate (14) that has a flat surface (16) located parallel to the cutting wheel (12). The flat surface (16) can allow a planar portion of the panel (24) to be slid thereover so that an edge of the panel can engage the cutting wheel (12). The flat surface (16) is spaced apart from the cutting wheel (12) by a distance so that, in use, the cutting wheel causes the removal of a portion of the edge so as to form a rebate edge (30) of the panel. Ideally, building panel (24) is a plasterboard panel which has an edge formed by a core encased between two surface layers.

### TECHNICAL FIELD

The present invention relates to an apparatus and a method for forming rebates in the edges of internal and external building panels. In particular, the invention relates to a machine for cutting a rebate edge in a plasterboard panel and in other commonly used building panels, such as those known in the industry as Villaboard™, Hardieboard™, and other kinds of fibre cement sheeting. The invention has particular application to plasterboard panels which have a core encased between two surface layers.

Although the background, objects and preferred embodiments of the invention will be hereinafter described with reference to a machine for cutting a rebate edge in a plasterboard panel, it is to be understood that the invention is not limited thereto but has wider application. For example, the machine may be used for cutting a rebate edge in a drywall panel or any building panel, so long as the panel can be machine cut along an edge to form a rebate.

It is to be understood that the terminology employed herein is for the purpose of description only and should not be regarded as limiting. For instance, the terms “comprising” or “comprises” are to be understood as meaning “including”, unless otherwise stated. Also, the term “rebate” (also referred to by the term “rabbet”) is to be understood as meaning any recess, groove or taper that is machine cut into the edge of a building panel, whether it be an internal or external panel.

### BACKGROUND ART

Plasterboard (also known as wallboard) is a form of internal building panel that consists of a gypsum plaster core encased between two surface layers of a heavy fibrous paper (also known as linerboard). The long edges of the plasterboard panel may be manufactured with a finished rebate or tapered edge, or with a straight or square cut edge, in which the paper is folded around the long edges to reinforce and protect the core. The ends of the plasterboard panel (its short edges) are cut square.

Rectangular panels of plasterboard are commonly joined to provide smooth and durable walls and ceilings for residential, commercial, industrial and other buildings, and are much easier and less expensive to install than other types of internal building panels.

Where factory manufactured lengths of plasterboard are supplied to building construction and renovation sites, it is sometimes necessary for the long edges to be trimmed on site to a size to suit installation at a particular wall or ceiling location.

For this purpose, a grinding machine is conventionally used that cuts a square edge along the long edge requiring trimming. When the newly cut square edge of a trimmed plasterboard panel is butt joined against the edge of a factory supplied plasterboard panel, the strength of the resulting joint may be poor or compromised by the presence of irregular shaped butting edges. Although drywall tape and joint compound, followed by a final sanding of the joint, is conventionally used to cover and maintain the butt joint, the poor strength of the joint may result in the problem of peaking and cracking of the so formed wall or ceiling along the joint between panels.

It has been found by the present inventor that this problem can be overcome by using a compact and portable cutting machine to form a rebate edge in a plasterboard panel requiring trimming, and then carrying out a method to (a) form a finished rebate along the same edge of the trimmed panel, (b) join together a finished rebate of one panel with a finished rebate of another like panel such that the rebate edges are aligned and form a rebated depression about a joint, and (c) cover and fill the rebated depression with filler material that, when dry and hardened, can be sanded to produce a smooth surface finish that masks the joint between the joined rebated edges. This will result in an internal wall or ceiling that is of improved strength and will resist peaking and cracking along the joint between the panels.

### DISCLOSURE OF INVENTION

It is, therefore, an object of the present invention to overcome or substantially ameliorate the disadvantages and problems of the aforementioned prior art, or at least provide a useful alternative.

It has been found by the present inventor that these and other objects of the invention may be achieved in general by providing a machine for cutting a rebate edge in a building panel, the machine comprising a cutting wheel adapted to be connected to a source of power for rotating the cutting wheel, a flat surface located parallel to the cutting wheel and adapted to allow a planar portion of the panel to be slid thereover so that an edge of the panel can engage the cutting wheel, the flat surface being spaced apart from the cutting wheel by a distance so that, in use, the cutting wheel causes the removal of a portion of the edge so as to form a rebate edge of the panel.

In a preferred application of the present invention, the building panel is a plasterboard panel which has an edge formed by a core encased between two surface layers, and wherein the flat surface is spaced apart from the cutting wheel by a distance so that, in use, the cutting wheel causes the removal of a layer portion of the core beneath one of the surface layers so as to form a rebate edge in the core of the panel.

Preferably, the flat surface of the machine is defined by a planar plate.

It is preferred that the surface layer beneath which a layer portion of the core is removed is the surface layer that slides over the flat surface.

In a preferred form, the machine further comprises a vacuum port adapted to be connected to a source of vacuum for drawing therethrough material that has been removed from a portion of the edge.

Preferably, the cutting wheel is operably connected to a hand held motor unit.

It is preferred that the machine further comprises an enclosure having an opening from which a part of the cutting wheel protrudes, the enclosure being adapted to capture the removed or cut away material. In this embodiment, the vacuum port accesses the enclosure so that the cut away material can be drawn from the enclosure through the vacuum port and an attached hose towards the source of the vacuum.

The machine may also include a handle connected to the planar plate.

According to another aspect of the present invention, there is provided a plasterboard panel having a rebate edge formed in its core by use of the aforementioned cutting machine.

According to yet another aspect of the present invention, there is provided a method for forming a finished rebate along an edge of a plasterboard panel having a core encased between two surface layers, the method comprising:

(a) using a cutting machine to form a rebate edge in the core of the panel, the rebate edge being formed by the cutting away of a layer portion of the core beneath one of the surface layers, and
(b) bringing together the surface layer beneath which the layer portion of the core has been cut away with a remaining layer portion of the core so as to form a finished rebate along the edge of the plasterboard panel.

Preferably, the cutting machine comprises a cutting wheel adapted to be connected to a source of power for rotating the cutting wheel, a flat surface located parallel to the cutting wheel and adapted to allow a planar portion of the plasterboard panel to be slid thereover so that an edge of the panel can engage the cutting wheel, the flat surface being spaced apart from the cutting wheel by a distance so that, in use, the cutting wheel causes the removal of a layer portion of the core beneath one of the surface layers so as to form a rebate edge in the core of the plasterboard.

It is preferred that the bringing together of the surface layer with the remaining layer portion of the core in step (b) is carried out with the application of glue or other adhesive material. For this purpose, the surface layer may be folded away from the remaining layer portion of the core to allow the adhesive material to be brushed on the remaining layer portion of the core. Alternatively, the adhesive material can be brushed on the underside of the surface layer. A polyvinyl acetate (PVA) based adhesive is preferably used, and the surface layers are preferably recycled paper.

According to still another aspect of the present invention, there is provided a method of forming an internal wall or ceiling from a plurality of plasterboard panels, the method comprising:

(a) providing two plasterboard panels that each have a finished rebate formed in accordance with the aforementioned method,
(b) joining together a finished rebate of one panel with a finished rebate of another panel such that the rebate edges are aligned and form a rebated depression on both sides of a joint, and
(c) covering and filling the rebated depression with filler material that, when dry and hardened, is sanded to produce a smooth surface finish that masks the joint between the joined rebate edges.

This will result in an internal wall or ceiling that is of improved strength and will resist peaking and cracking along the joint between the panels.

Preferably, step (c) is carried out with the application of an adhesive tape over the joint, then with the application of a joint compound over the adhesive tape, and then with the sanding of the joint compound to form the smooth surface.

There has been thus outlined, rather broadly, the more important features of the invention in order that the detailed description thereof that follows may be better understood and put into practical effect, and in order that the present contribution to the art may be better appreciated.

There are additional features of the invention that will be described hereinafter. As such, those skilled in the art will appreciate that the conception, upon which the disclosure is based, may be readily utilized as the basis for designing other apparatus and methods for carrying out the objects of the present invention. It is important, therefore, that the broad outline of the invention described above be regarded as including such equivalent constructions in so far as they do not depart from the spirit and scope of the present invention.

### BRIEF DESCRIPTION OF THE DRAWINGS

The invention will be better understood and objects other than those set forth above will become apparent when consideration is given to the following detailed description thereof. Such description makes reference to the accompanying drawing, in which:

FIG. 1 is a bottom view of a portable rebate cutting machine according to a preferred embodiment of the invention,

FIG. 2 is a top view of the machine shown in FIG. 1,

FIG. 3 is a side view of the machine shown in FIGS. 1 and 2,

FIG. 4 is a front view of the machine shown in FIGS. 1 to 3,

FIG. 5 is a rear view of the machine shown in FIGS. 1 to 4,

FIG. 6 is a bottom perspective view of the machine of FIGS. 1 to 5,

FIG. 7 is a top perspective view of the machine of FIGS. 1 to 6,

FIG. 8 is another top perspective view showing the machine of FIGS. 1 to 7 in use on a plasterboard panel, with a part of the planar plate shown cut away to reveal the cutting operation,

FIG. 9 is another top perspective view showing the machine of FIGS. 1 to 7 in use on a fiber cement sheet panel, with a part of the planar plate shown cut away to reveal the cutting operation,

FIG. 10 is a perspective view of a portion of a plasterboard panel having a rebate edge formed in the manner as shown in FIG. 8, wherein the rebate edge has been formed in the core of the plasterboard panel after completion of the cutting operation that causes the cutting away of a layer portion of the core beneath a surface layer so that the remaining layer portion of the core can define the rebate edge,

FIG. 11 is a perspective view of the plasterboard panel having the rebate edge shown in FIG. 10 to which is being applied a glue,

FIG. 12 is a perspective view of the plasterboard panel having the rebate edge shown in FIG. 11 after the surface layer has been pressed down against all glued surfaces of the rebate edge to form a finished rebate,

FIG. 13 is a perspective view showing the finished rebate of one plasterboard panel joined together with a finished rebate of another plasterboard panel such that the rebate edges are aligned and form a rebated depression on both sides of a joint, and showing the application of an adhesive tape over the joint, and

FIG. 14 is a perspective view of the joined plasterboard panels shown in FIG. 13 after having the taped together rebated depression filled with a filler or joint compound that, when dry and hardened, is sanded to form a smooth surface for use as an internal wall or ceiling.

### MODES FOR CARRYING OUT THE INVENTION

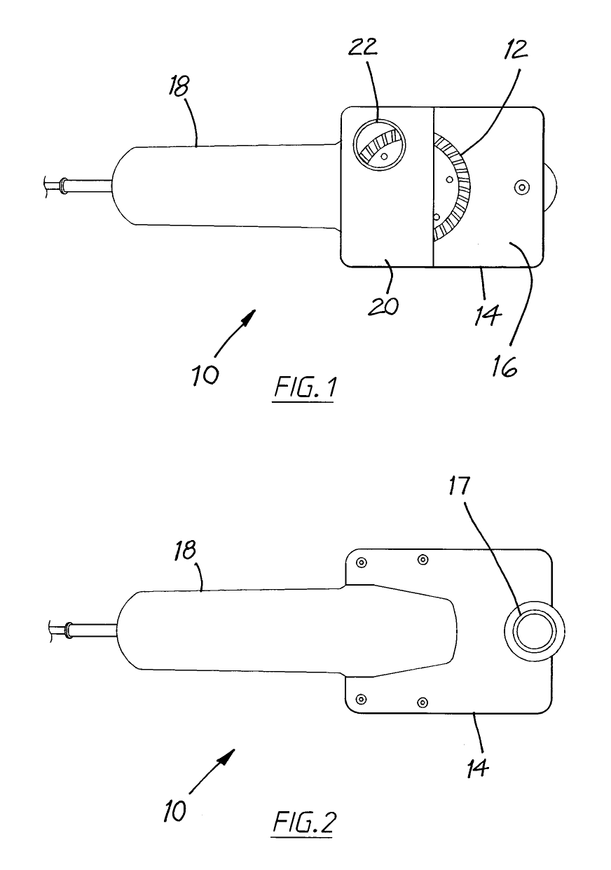

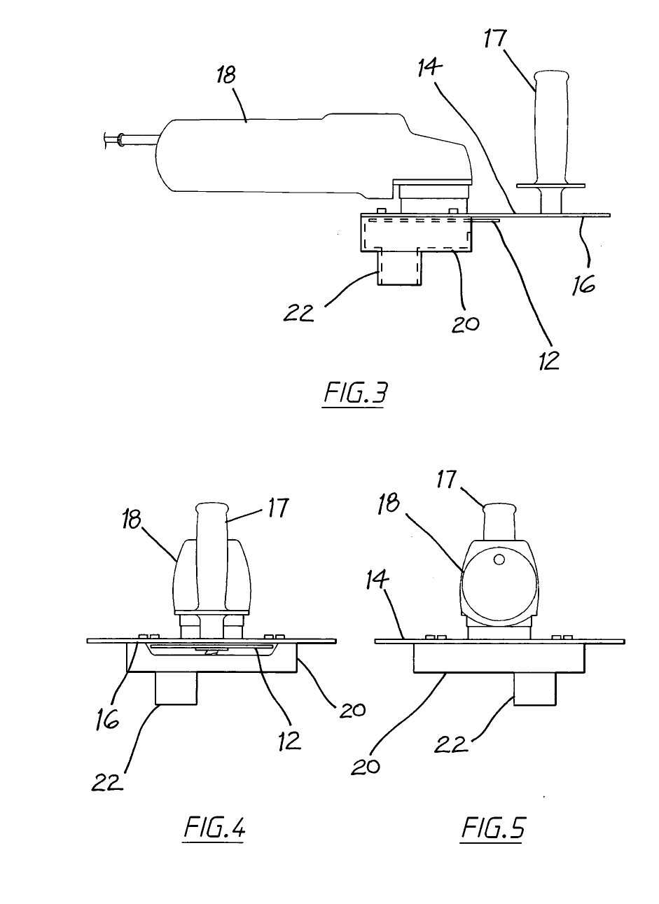

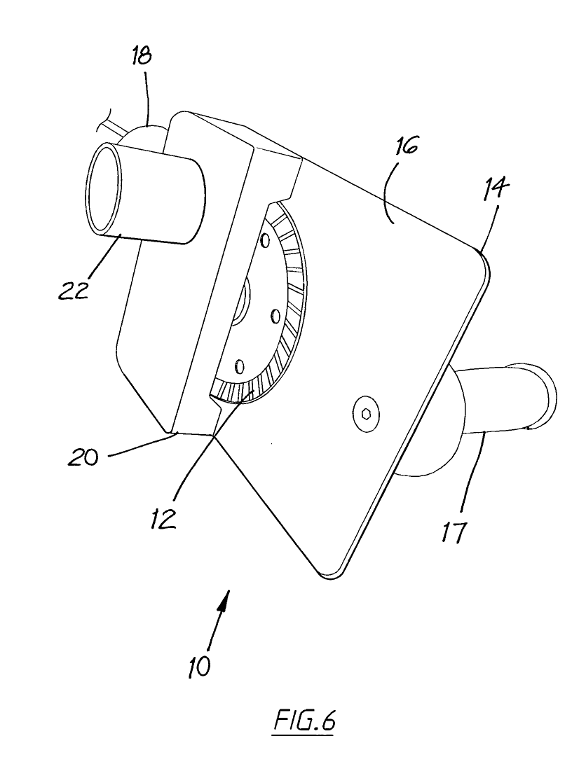

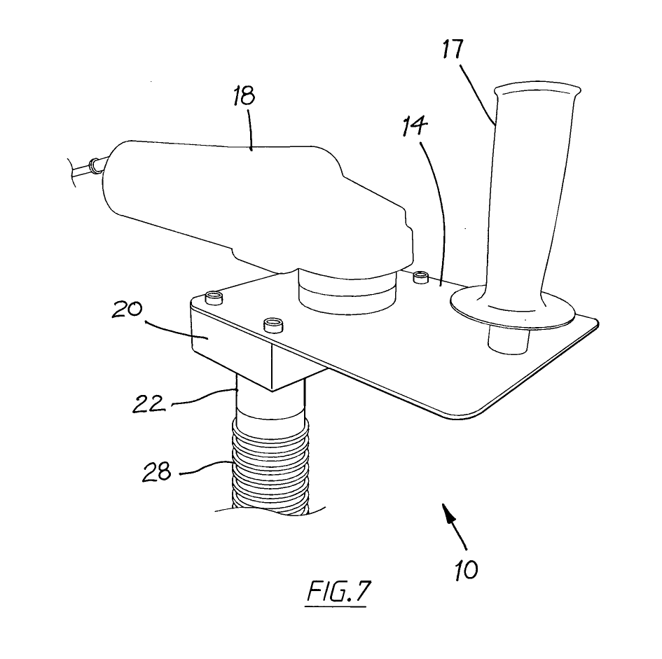

With reference now to the above summarized drawings of FIGS. 1 to 9, a rebate cutting machine embodying the principles and concepts of the present invention and generally designated by the reference numeral 10 will now be described.

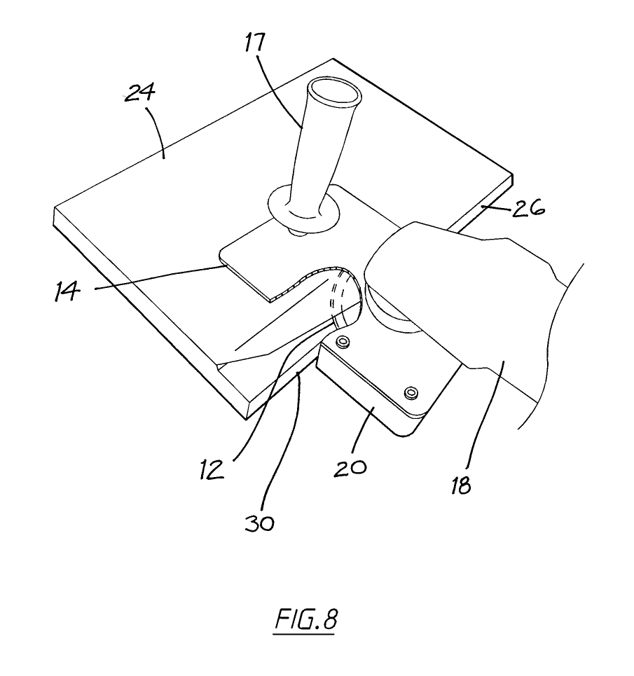

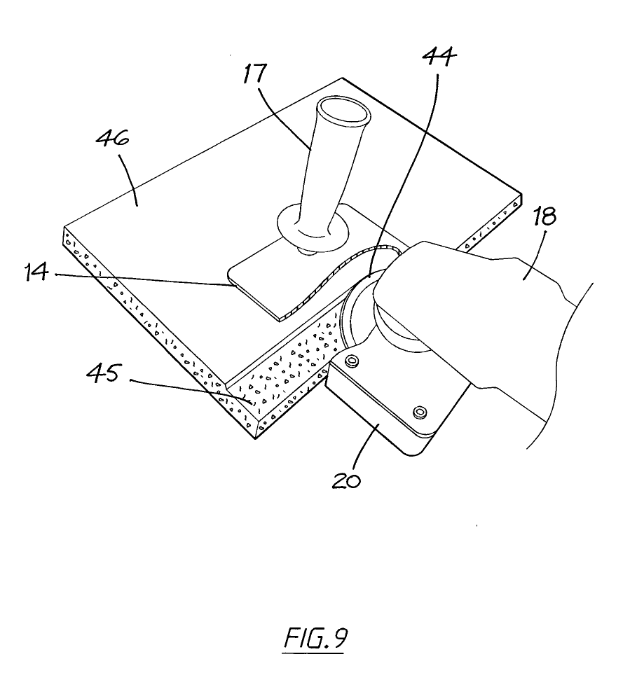

The machine 10, which is portable, is able to cut a rebate edge in a core of a plasterboard panel having a core of gypsum plaster encased between two surface layers of hard recycled paper (as shown in FIG. 8), and has a suitable cutting wheel 12, a planar plate 14 defining a flat surface 16, a handle 17, a hand held motor unit 18, an enclosure 20, and a vacuum port 22 accessing the enclosure 20.

The cutting wheel 12, which is in the form of a conventional 4 inch diameter “slim line” cutting disc, is operably connected to a rotatably driven shaft of the motor unit 18. Part of the cutting wheel 12 protrudes from an opening of the enclosure 20. The cutting disc may have a 1.2 mm thick diamond tipped cutting blade.

The flat surface 16 of the planar plate 14 is located parallel to, but spaced apart from, the cutting wheel 12. A piece of plasterboard 24 (as shown in FIG. 8) can be slid over the flat surface 16 so that one of its long edges 26 engages the cutting wheel 12.

The flat surface 16 is spaced apart from the plane of the cutting wheel 12 by a distance such that, during each cutting operation, the cutting wheel 12 causes the removal or cutting away of a layer portion of the core beneath the surface layer that slides over the flat surface 16. This layer portion of gypsum plaster core that is cut away is about 2 to 3 mm in depth and about 32 to 34 mm in width from the long edge 26 of the plasterboard 24.

The cut away material is in the form of a particulate dust that is captured inside the enclosure 20, from where it is drawn through the vacuum port 22 and an attached hose 28 towards a source of vacuum.

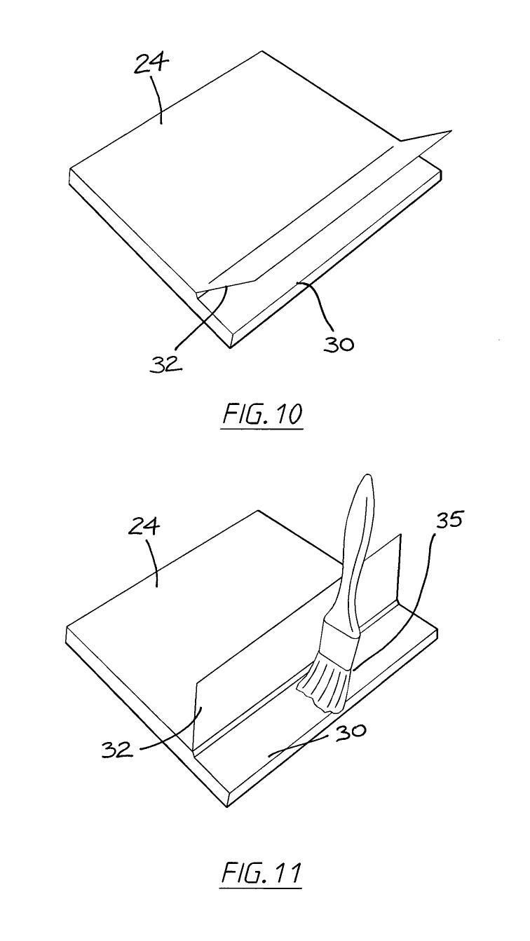

The cutting operation of the machine 10 forms a rebate edge 30 in the core of the plasterboard panel (as shown in FIGS. 8 and 10).

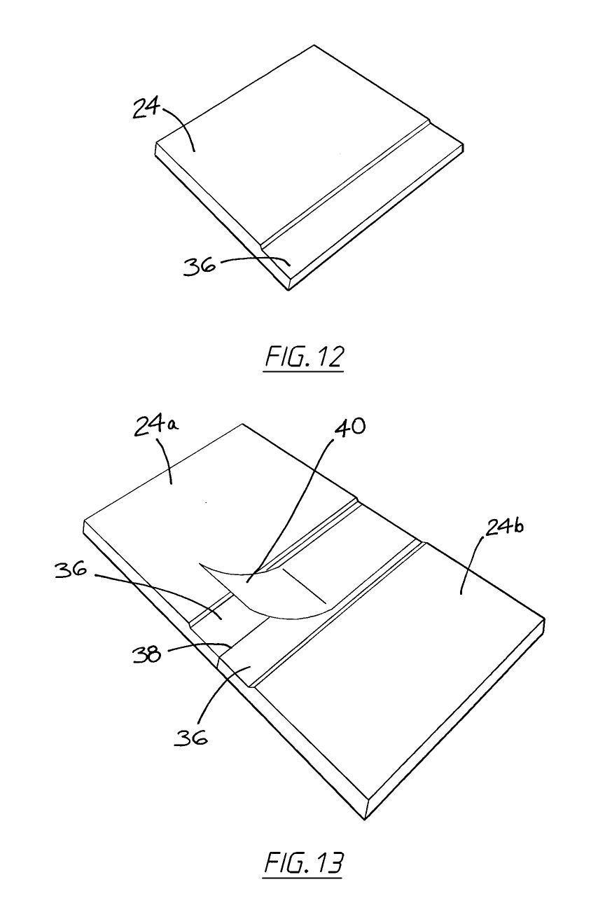

The plasterboard panel must then have the rebate edge 30 in its core “finished” into a rebate along the same edge in the panel (as shown in FIGS. 11 and 12). This is achieved by having the surface layer of hard paper 32, which had previously been slid over the flat surface 16 of the machine 10 and is no longer attached to a backing of the core, folded away from the core, and then, in one approach, applying glue by brush 35 to the rebate edge 30 (as shown in FIG. 11), before pressing the surface layer of hard paper 32 firmly thereupon for connection by bonding with the glue, and so as to form a finished rebate 36 (as shown in FIG. 12).

In an alternative approach, glue is applied to the underside of the unbacked surface layer of hard paper 32, before the pressing step.

In yet another approach, no adhesive material is applied, and the surface layer of hard paper is connected to the remaining layer of the core defining the rebate edge 30 by the simple application of pressure.

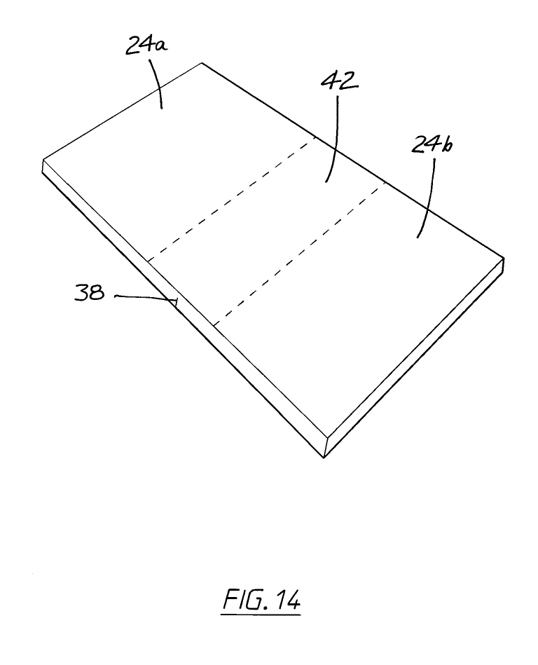

Two plasterboard panels 24a and 24b, each having the aforementioned finished rebate 36, are then interconnected for the purpose of ultimately forming an internal wall or ceiling (as shown by FIG. 14). This is achieved by, firstly, joining together the panels 24a, 24b along respective edges so that the finished rebates along each edge are aligned and form a rebated depression across the middle of which is joint 38 (see FIG. 13) and, secondly, masking the joint 38 to form a smooth surface in the internal wall or ceiling by filling the rebated depression with plaster filler material that, when dry and hardened, is sanded to produce a smooth surface finish that masks the joint between the joined rebate edges.

The joining together of the panels along respective edges of the finished rebates is carried out with the application of an adhesive tape 40 over the joint 38 (see FIG. 13).

The subsequent application of a filler or joint compound in the rebated depression over the adhesive tape is followed by sanding of the joint compound to form the smooth surface 42 (see FIG. 14) in the internal wall or ceiling formed by the two panels 24a and 24b.

The machine 10 can be refitted or initially assembled with a suitable cutting wheel 44 for forming a rebate 45 in a fiber cement sheet panel 46 (as shown in FIG. 9). If Villaboard™ building panels are used, the cutting disc may have a 2.2 mm thick diamond tipped cutting blade.

It will be apparent to persons skilled in the art that the portable rebate cutting machine of the present invention may be suited to many different kinds of building panels, both interior and exterior, and may be made from many suitable component parts and materials.

It will also be readily apparent from the above that there are various advantages of the present invention.

One advantage is that, by using the machine and method of the present invention, an internal wall or ceiling formed by plasterboard panels can be provided that is of improved strength and will resist peaking and cracking along the joint between the panels.

It will also be readily apparent to persons skilled in the art that various modifications may be made in details of design and construction of the embodiments of the portable rebate cutting machine, and in the steps of the method described above, without departing from the scope or ambit of the present invention.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates before the filing date of this patent application.

1. A machine for cutting a rebate edge in a building panel, the machine comprising a cutting wheel adapted to be connected to a source of power for rotating the cutting wheel, a flat surface located parallel to the cutting wheel and adapted to allow a planar portion of the panel to be slid thereover so that an edge of the panel can engage the cutting wheel, the flat surface being spaced apart from the cutting wheel by a distance so that, in use, the cutting wheel causes the removal of a portion of the edge so as to form a rebate edge of the panel.

2. The machine of claim 1 wherein the building panel is a plasterboard panel which has an edge formed by a core encased between two surface layers, and wherein the flat surface is spaced apart from the cutting wheel by a distance so that, in use, the cutting wheel causes the removal of a layer portion of the core beneath one of the surface layers so as to form a rebate edge in the core of the panel.

3. The machine of claim 1 wherein the flat surface of the machine is defined by a planar plate.

4. The machine of claim 2 wherein the surface layer beneath which a layer portion of the core is removed is the surface layer that slides over the flat surface.

5. The machine of claim 1 and further comprising a vacuum port adapted to be connected to a source of vacuum for drawing therethrough material that has been removed from a portion of the edge.

6. The machine of claim 1 wherein the cutting wheel is operably connected to a hand held motor unit.

7. The machine of claim 1 and further comprising an enclosure having an opening from which a part of the cutting wheel protrudes, the enclosure being adapted to capture the removed or cut away material.

8. The machine of claim 7 wherein the vacuum port accesses the enclosure so that the cut away material can be drawn from the enclosure through the vacuum port and an attached hose towards the source of the vacuum.

9. The machine of claim 1 and further including a handle connected to the planar plate.

10. A method for forming a finished rebate along an edge of a plasterboard panel having a core encased between two surface layers, the method comprising:
(a) using a cutting machine to form a rebate edge in the core of the panel, the rebate edge being formed by the cutting away of a layer portion of the core beneath one of the surface layers, and
(b) bringing together the surface layer beneath which the layer portion of the core has been cut away with a remaining layer portion of the core so as to form a finished rebate along the edge of the plasterboard panel.

11. The method of claim 10 wherein the cutting machine comprises a cutting wheel adapted to be connected to a source of power for rotating the cutting wheel, a flat surface located parallel to the cutting wheel and adapted to allow a planar portion of the plasterboard panel to be slid thereover so that an edge of the panel can engage the cutting wheel, the flat surface being spaced apart from the cutting wheel by a distance so that, in use, the cutting wheel causes the removal of a layer portion of the core beneath one of the surface layers so as to form a rebate edge in the core of the plasterboard.

12. The method of claim 11 wherein the bringing together of the surface layer with the remaining layer portion of the core in step (b) is carried out with the application of glue.

13. A method of forming an internal wall or ceiling from a plurality of plasterboard panels, the method comprising:
(a) providing two plasterboard panels that each have a finished rebate formed in accordance with the aforementioned method,
(b) joining together a finished rebate of one panel with a finished rebate of another panel such that the rebate edges are aligned and form a rebated depression on both sides of a joint, and
(c) covering and filling the rebated depression with filler material that, when dry and hardened, is sanded to produce a smooth surface finish that masks the joint between the joined rebate edges.

14. The method of claim 13 wherein step (c) is carried out with the application of an adhesive tape over the joint, then with the application of a filler or joint compound over the adhesive tape, and then with the sanding of the filler or joint compound to form the smooth surface.
